(19) United States
(12) Patent Application Publication
(10) Pub. No.: US 2011/0196806 A1
(43) Pub. Date: Aug. 11, 2011

(54) Systems, Methods, and Computer Program Products for Creation and Trading of Enhanced Bonds

(75) Inventors: Richard K. MacWilliams, New Orleans, LA (US); John Andrew McQuown, Sonoma, CA (US)

(73) Assignee: eBond Advisors LLC, New York, NY (US)

(21) Appl. No.: 12/839,218

(22) Filed: Jul. 19, 2010

Related U.S. Application Data
(63) Continuation-in-part of application No. 12/703,073, filed on Feb. 9, 2010.

(51) Int. Cl. G06Q 40/00; G06Q 90/00

(52) U.S. Cl. 705/36 R; 705/500; 705/37

(57) ABSTRACT

A system, method, and computer program product are provided for the creation of enhanced bonds. Enhanced bonds are backed by the security of a credit default swap contract without the need for separate purchase thereof. A bond dealer is able to exchange a traditional bond instrument, which has been issued in a manner that permits the exchange, for enhanced bonds by selling the credit default swap contract to an eBond LLC and tendering the exchangeable bonds for eBonds through the bond indenture trustee. The enhanced bond facilitator calculates the exchange rates for these instruments at the time of exchange based on several variables, including the cost of the underlying credit default swap contract for a desired level of protection.

### CROSS-REFERENCE TO RELATED APPLICATIONS

The present application is a continuation-in-part of U.S. patent application Ser. No. 12/703,073, filed Feb. 9, 2010, entitled “Systems, Methods, and Computer Program Products for Creation and Trading of Enhanced Bonds” (Atty. Dkt. No. 2904.0020000), which is incorporated by reference herein in its entirety.

### BACKGROUND

1. Field

Embodiments of the present invention relate generally to investment vehicles, and, more particularly, to bonds and credit default swaps.

2. Background

The majority of bond investors seek standard bond structures that have very low or no default risk. In many cases, bond investors may be required, such as by fiduciary duties, to invest only in these standard bond structures having low or no default risk.

Credit rating agencies such as MOODY'S CORPORATION and STANDARD & POOR'S, both of New York City, N.Y., have historically provided a rating indicating the likelihood that the debtor will be able to repay the bond. These ratings are provided using each agency's particular nomenclature, such as prime ratings of Aaa (Moody's)/AAA (S&P).

A corporation issuing bonds to raise capital benefits from a higher credit rating. High grade investors will typically flock to the security provided by investment grade bonds, and corporations with prime ratings can therefore issue bonds at comparatively low costs, such as at lower coupon rates. On the other side of the spectrum, high yield investors seek out bonds that they believe may be underrated, such that the corporation issuing them will actually be able to pay back the bond at the significantly higher costs at which they had to be purchased. High yield investors are willing to take this risk due to the offsetting reward if they have chosen the bond correctly.

In between, typically at the Baa (Moody's)/BBB (S&P) level, bonds become attractive to both high grade and high yield investors. Investor behavior at this point on the credit spectrum reveals the conundrum facing investors trying to maximize returns while following credit rating based investment guidelines. High grade investors, particularly fiduciaries, are unable to invest in the high yield grades per their investment policy guidelines. This behavior penalizes bond issuers with lower credit ratings, such that only the far more limited pool of high yield investors are available as purchasers of their bonds, pushing up their borrowing costs or potentially excluding them from the bond market entirely.

The current market structure therefore makes it difficult for investors to purchase bonds of a particular issuer at the precise default risk they desire. Previous attempts to give investors this ability involved the creation of “structured” securities to incorporate credit enhancements. However, these securities were not standard bond structures, and therefore the general investment public had difficulty pursuing them. Nor did these securities have any effect in lowering the funding costs for issuers, thereby making them less desirable for all parties.

Another problem with the current market structure is the high transaction costs involved with buying and trading bonds. Currently, investors frequently seek to reduce risk by selling one bond and purchasing another, potentially reducing their default risk to one bond issuer in favor of a different bond issuer. Each purchase and sale in this process carries high transaction costs, which can offset any gains made. As transaction costs are commonly built into the purchase or sale price of a bond on the secondary market, bond dealers incur these transaction costs at every step of this risk-reduction procedure and pass them along to investors

Accordingly, what is desired is the ability to allow investors to purchase bonds with a specific desired risk regardless of issuer and provide a mechanism for dealers to significantly reduce transaction costs compared to those available today. The consequence of these abilities represents a material improvement in the structure of the corporate bond and sovereign debt markets creating better return opportunities for investors and lower borrowing costs for issuers.

### SUMMARY

Embodiments of the invention include a method comprising purchasing a credit default swap contract on an exchangeable bond, instructing a trustee to exchange the exchangeable bond for an enhanced bond for delivery to an investor of the enhanced bond, and delivering the credit default swap contract to an account held at a clearing member.

Additional embodiments of the invention include an article of manufacture including a computer-readable storage medium having stored thereon computer-executable instructions, execution of which, by one or more computing devices, causes the computing devices to perform operations comprising purchasing a credit default swap contract on an exchangeable bond, instructing a trustee to exchange the exchangeable bond for an enhanced bond for delivery to an investor of the enhanced bond, and delivering the credit default swap contract to an account held at a clearing member.

Additional embodiments of the invention include a system comprising a memory configured to store modules comprising a purchasing module configured to purchase a credit default swap contract on an exchangeable bond, an instructing module configured to instruct a trustee to exchange the exchangeable bond for an enhanced bond for delivery to an investor of the enhanced bond, and a delivering module configured to deliver the credit default swap contract to an account held at a clearing member, and one or more processors configured to process the modules.

Additional embodiments of the invention include a method comprising acquiring an original issue discount exchangeable bond, receiving payment from an investor for an enhanced bond based on the exchangeable bond, requesting exchange of the exchangeable bond to the enhanced bond, the enhanced bond backed by a credit default swap contract, and delivering the enhanced bond to the investor.

Additional embodiments of the invention include an article of manufacture including a computer-readable storage medium having stored thereon computer-executable instructions, execution of which, by one or more computing devices, causes the computing devices to perform operations comprising acquiring an original issue discount exchangeable bond, receiving payment from an investor for an enhanced bond based on the exchangeable bond, requesting exchange of the exchangeable bond to the enhanced bond, the enhanced bond backed by a credit default swap contract, and delivering the enhanced bond to the investor.

Additional embodiments of the invention include a system comprising a memory configured to store modules comprising an acquiring module configured to acquire an original issue discount exchangeable bond, a receiving module configured to receive payment from an investor for an enhanced bond based on the exchangeable bond, a requesting module configured to request exchange of the exchangeable bond to the enhanced bond, the enhanced bond backed by a credit default swap contract, and a delivering module configured to deliver the enhanced bond to the investor, and one or more processors configured to process the modules.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 is a diagram illustrating the interactions between financial entities involved in the creation of eBonds, in accordance with an embodiment of the present invention.

FIG. 2 is a diagram illustrating the components of an eBond exchange, in accordance with an embodiment of the present invention.

FIG. 3 is a flowchart illustrating steps by which a bond issuer is able to create the initial xBond offering which can be exchanged into eBonds, in accordance with an embodiment of the present invention.

FIG. 4 is a flowchart illustrating steps by which a dealer is able to exchange xBonds for eBonds, in accordance with an embodiment of the present invention.

FIG. 5 is a flowchart illustrating steps by which an eBond facilitator facilitates the eBond exchange process, in accordance with an embodiment of the present invention.

FIG. 6 is a flowchart illustrating a course of performance by an eBond LLC, in accordance with an embodiment of the present invention.

FIG. 7 is a diagram illustrating components of a further eBond exchange, in accordance with an embodiment of the present invention.

FIG. 8 is a flowchart illustrating steps by which an immediate xBond-to-eBond exchange is effected, in accordance with an embodiment of the present invention.

FIG. 9 depicts an example computer system in which embodiments of the present invention may be implemented.

Embodiments of the present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### I. Introduction

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, and within the scope and spirit of the present invention.

Reference to modules in this specification and the claims means any combination of hardware or software components for performing the indicated function. A module need not be a rigidly defined entity, such that several modules may overlap hardware and software components in functionality. For example, a software module may refer to a single line of code within a procedure, the procedure itself being a separate software module. One skilled in the relevant arts will understand that the functionality of modules may be defined in accordance with a number of stylistic or performance-optimizing techniques, for example.

Credit default swaps (“CDS”) are a type of derivative investment that allow one party to transfer the default risk of an asset to another party. A typical CDS contract involves a buyer making regular payments to a seller of the CDS, with the buyer receiving a payoff if a predetermined credit instrument, such as a bond, goes into default.

A consequence of this is the ability to use a CDS to offset some or all of the default risk of holding a bond. Although a buyer of a CDS contract need not have financial exposure to the instrument, in this case a bond, bond holders can purchase CDS contracts so they can collect on the bond if the bond issuer remains solvent, or on the CDS in the event that the bond issuer defaults. However, this arrangement poses a number of difficulties. For example, an investor would have to engage in multiple transactions in order to express a single financial point of view, which requires additional transaction costs. Additionally, not all investors are permitted to purchase every grade of bond, nor CDS contracts.

A large problem traditionally has also involved the additional exposure a CDS contract brings. Counterparties to a CDS contract run the risk that the other will default on his obligations, leaving perhaps a buyer who cannot collect from the seller if a third party has defaulted on a bond, or a seller who cannot collect ongoing payments from a buyer who has defaulted. For a buyer who also has financial exposure to the subject financial instrument, in this case a bond, the risk of a default by both the bond issuer and the CDS seller is perhaps an insurmountable hurdle to engaging in this type of arrangement.

More recently, regulations have gone into effect to reign in some of the problems associated with CDS contracts and to otherwise stabilize the derivatives market. Notably, in the case of CDS contracts, central clearing houses or central counterparties (“CCPs”) have been created which act as the counterparty to both the CDS seller and the CDS buyer. CCPs are, at present, government-approved entities that meet certain requirements to guarantee their stability. The CCPs, as counterparty to both buyer and seller of CDS contracts, bear responsibility to each party should the other default.

The guarantee provided by the availability of a CCP for the purchase of CDS contracts allows for an innovative solution to offering a single financial instrument that incorporates the yield of a bond with the security of a CCP-backed CDS. Specifically, a new type of investment termed an enhanced bond (“eBond”) is created that combines corporate bonds with CDS contracts for those same corporate bonds, in accordance with an embodiment of the present invention.

### II. Enhanced Bond Creation Overview

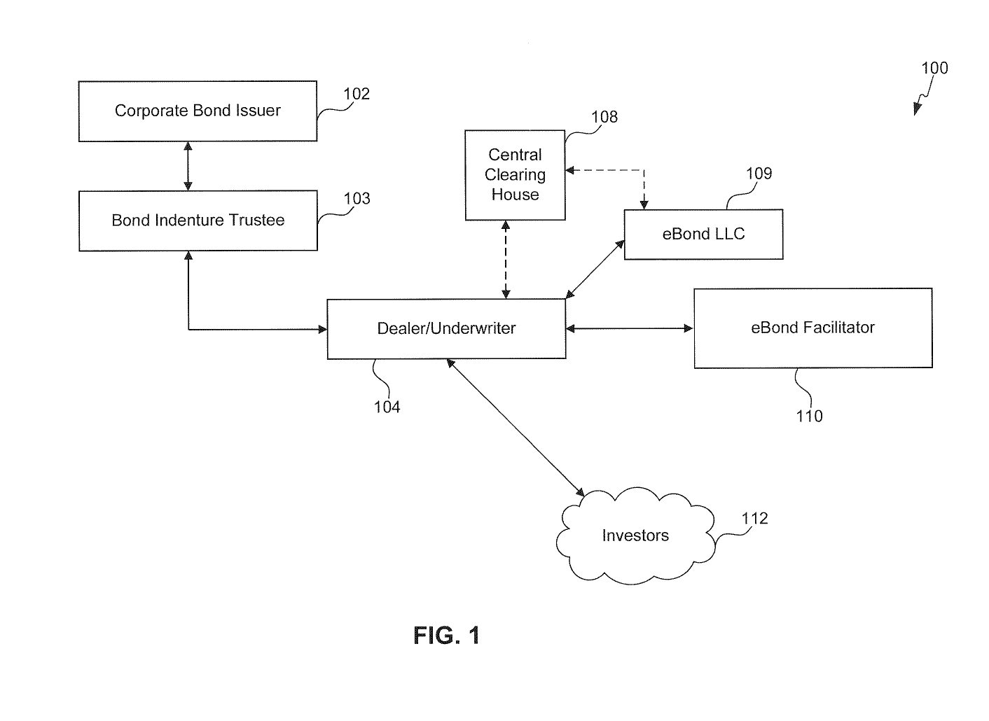

FIG. 1 is a diagram 100 illustrating the interactions between financial entities involved in the creation of eBonds, in accordance with an embodiment of the present invention. One skilled in the relevant arts will appreciate that other entities may be involved other than those shown, and a single entity may serve more than one of the roles illustrated in diagram 100. Accordingly, the interactions shown in diagram 100 are provided by way of example, and not limitation.

Central clearing house 108 is equivalent to the previously-discussed CCP, in accordance with an embodiment of the present invention. CCP 108 acts as a counterparty to both a CDS seller and a CDS buyer. As will be further discussed below, in a non-limiting exemplary embodiment, dealer 104 will serve as the CDS seller, and an eBond LLC 109 will serve as the CDS buyer.

A corporate bond issuer 102 prepares a bond offering. This process includes the creation of a bond indenture and the identification of a bond indenture trustee 103 to manage the specifics of the bond indenture. The bond indenture specifies, for example, the obligations of corporate bond issuer 102 to repay the bond, and other information such as the maturity date of the bond.

In accordance with an embodiment of the present invention, a bond indenture for an exchangeable bond (“xBond”) further specifies exchangeability provisions for the bond. As will be further described herein, the bond indenture includes a reference to a CDS which can be provided in exchange for conversion of the xBond to a particular eBond.

A corporate bond issuer 102 then offers the xBonds for sale to dealer 104, in accordance with an embodiment of the present invention. In accordance with a further embodiment of the present invention, dealer 104 serves as an “underwriter,” purchasing all of the bonds offered by corporate bond issuer 102 for resale. Although dealer 104 is presented as a single entity in diagram 100, one skilled in the relevant arts will recognize, as previously noted, that several parties may collaborate (e.g., as a syndicate) in order to perform the functions attributed herein to dealer/underwriter 104.

Traditionally, dealer 104 would then resell the corporate bonds directly to investors 112. Investors 112 would then generally consider the credit ratings of the bonds and purchase them at a price determined, at least in part, by such factors as the bond issuer's credit rating, the bond's coupon amount, maturity date, and par value. However, for the reasons previously discussed, investors 112 may be limited by which bonds they may purchase.

In accordance with an embodiment of the present invention, dealer 104 can purchase xBonds from bond issuer 102 and sell CDS contracts to an eBond LLC 109. Dealer 104 is able to act as the principal for the CDS contracts in accordance with an embodiment of the present invention. However, one skilled in the relevant arts will appreciate that the CDS contracts can be obtained by dealer 104 through other means.

In accordance with a further embodiment of the present invention, dealer 104 novates the CDS contract to CCP 108, such that CCP 108 becomes the obligor on the contract. This is accomplished by meeting CCP's 108 requirements for the creation of the CDS contract, which then permits the novation to take place. The effect of this novation is that CCP 108 becomes the buyer to a CDS contract seller, and the seller to a CDS contract buyer. In this case, CCP 108 is obligated to meet the dealer's 104 obligations as CDS contract seller to eBond LLC 109, and to meet eBond LLC's 109 obligations as CDS contract buyer to dealer 104. One skilled in the relevant arts will appreciate that other methodologies for backing a CDS contract may be used, and novation to CCP 108 is provided by way of example, and not limitation.

With the CDS contract sold to eBond LLC 109, dealer 104 then is then able to exchange the xBonds for eBonds per the provisions of the bond indenture, in accordance with a further embodiment of the present invention. An exemplary mechanism of this exchange, as well as a description of the eBond LLC is described further below.

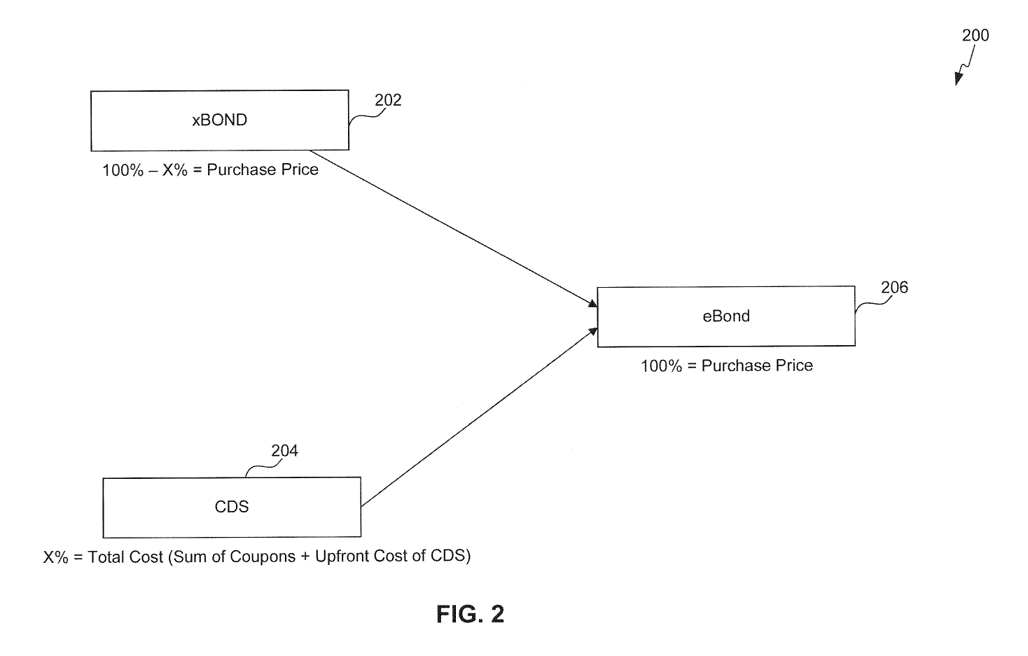

FIG. 2 is a diagram 200 illustrating the components of an eBond exchange, in accordance with an embodiment of the present invention. An xBond 202 is, by its nature, exchangeable into an eBond 206. The requirements for this exchange are provided by the bond indenture of the xBond, which includes a reference to a CDS 204, in accordance with a further embodiment of the present invention. One skilled in the relevant arts will appreciate that the exchange described in FIG. 2 can take place on an electronic trading platform without manual intervention.

Diagram 100 of FIG. 1 and diagram 200 of FIG. 2 will be discussed in further detail below with the specifics of the eBond mechanisms.

### III. Creation of Exchangeable Bonds—A Bond Issuer's View

A bond issuer, such as corporate bond issuer 102, enters into an agreement with eBond facilitator 110 to specify the requirements for the creation of xBonds 202, in accordance with an embodiment of the present invention. An exemplary eBond facilitator is eBond Advisors, LLC, formed under the laws of Delaware. As previously noted, one skilled in the relevant arts will understand that any number of entities may specify the parameters for the creation of xBonds 202. Bonds issued by bond issuer 102 which meet these requirements are the bonds that a dealer 104 can exchange into eBonds 206, in accordance with an embodiment of the present invention. These requirements are specified within the bond indenture for xBonds 202.

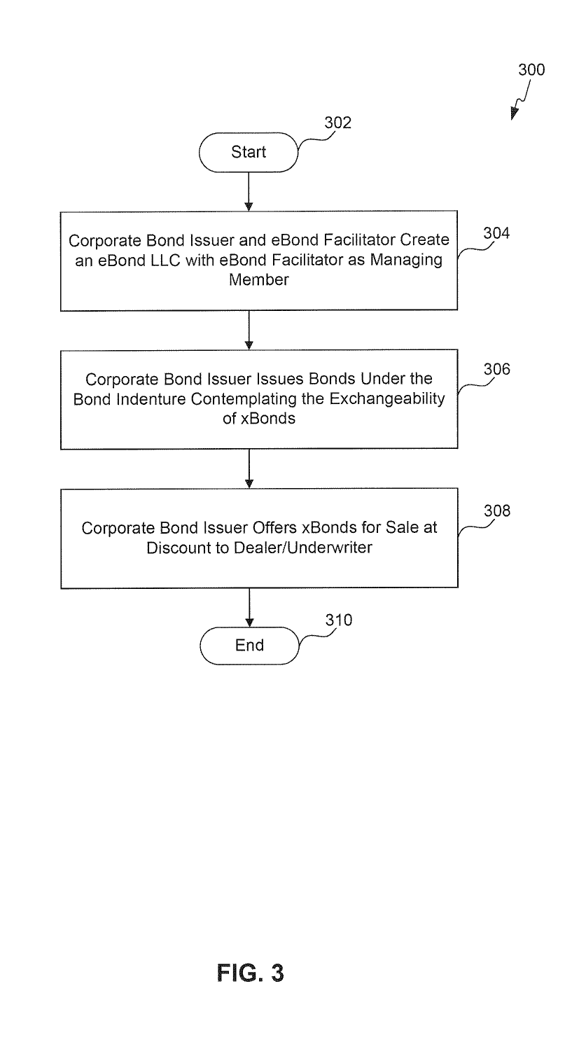

FIG. 3 is a flowchart 300 illustrating steps by which bond issuer 102 is able to create the initial xBond offering which can be exchanged into eBonds, in accordance with an embodiment of the present invention. The method begins at step 302 and proceeds to step 304 where the aforementioned agreement between bond issuer 102 and eBond facilitator 110 results in the formation of, for example, an eBond LLC 109, in accordance with an embodiment of the present invention. For the purposes of the discussion herein, actions taken by, or on behalf of, eBond LLC 109 are generally discussed in the context of eBond facilitator 110 in its role as managing member. The structure and obligations of eBond LLC 109 are further discussed below. Although the present description will refer to an LLC corporate structure, one of skill in the relevant arts will recognize that corporate structures other than an LLC may also be created without departing from the spirit and scope of the present invention.

At step 306, bond issuer 102 issues bonds in accordance with the requirements set forth in the aforementioned bond indenture agreement contemplating the exchangeability of xBonds 202, in accordance with an embodiment of the present invention. These requirements, examples of which will be provided below, are specified in the bond's indenture agreement, which include reference to the bonds' ability to be exchanged into eBonds. These bonds are termed xBonds 202, as previously discussed. Aside from compliance with the specified requirements, xBonds 202 are otherwise noimal corporate bonds that bond issuer 102 would otherwise issue. They can be traded in the same manner as any other corporate bond issued by bond issuer 102, and would be associated with bond issuer's 102 credit rating, in accordance with an embodiment of the present invention.

Bond issuer 102 then offers xBond 202 for sale at step 308, in accordance with an embodiment of the present invention. In accordance with a further embodiment of the present invention, this xBond 202 is offered at a discounted price to a dealer 104, as an Original Issue Discount (“OID”) bond. This discount reflects the difference between a corresponding eBond 206 which will be the subject of a later exchange and the cost of a CDS 204 used to exchange xBond 202 into eBond 206, in accordance with an additional embodiment of the present invention. In accordance with a further embodiment of the present invention, xBond 202 is offered at par value to dealer 104, reflecting a discount from a premium value to be charged for a corresponding eBond 206. One skilled in the relevant arts will appreciate that different pricing methodologies may be used, and the use of OID/par and par/premium is shown by way of example, and not limitation. The logistics behind this exchange are further discussed below. The method then ends at step 310.

By this process, bond issuer 102 has placed on the market more than a simple corporate bond with its associated bond rating. The ability to exchange the issued xBond 202 into an eBond 206 creates myriad investment opportunities, allowing the investor to exchange xBond 202 into a particular eBond 206 which represents the investor's desired level of risk. Transaction costs normally associated with the sale and purchase of bonds to realign a bond portfolio with a particular risk objective are thereby reduced or avoided entirely.

In accordance with a non-limiting embodiment of the present invention, the bond indenture can be used to specify a requirement for the creation of an xBond 202 for a maturity date which coincides with a particular CDS 204 offering. This can be facilitated by specifying, in the bond indenture, a particular date on which a created xBond 202 will mature. In a non-limiting example, the aforementioned bond indenture may specify that bond issuer 102 should issue xBonds 202 such that they mature on the 20th of December, March, June, or September. By having xBonds 202 and referenced CDS contracts 204 mature on the same date, the pricing of eBonds 206 is made more efficient, although one skilled in the relevant arts will appreciate that other means of aligning the effective periods for xBonds 202 and CDS contracts 204 may be used, or not at all. As will be further discussed below, CDS contract 204 is provided to eBond LLC 109 for holding as collateral for an enhanced CDS (“eCDS”) which it issues, in accordance with a further embodiment of the present invention.

One skilled in the relevant arts will recognize, however, that it is not strictly necessary for CDS contracts 204 to mature on the same date as xBonds 202. In accordance with another embodiment of the present invention, CDS contract 204 matures past the maturity date of xBonds 202, even though this has the effect of providing unnecessary additional coverage. In accordance with still another embodiment of the present invention, the maturity date of the eCDS is configured to coincide with the maturity date of xBonds 202, regardless of the maturity date of the underlying CDS contracts 204.

### IV. Exchanging Xbonds for Ebonds—a Dealer's View

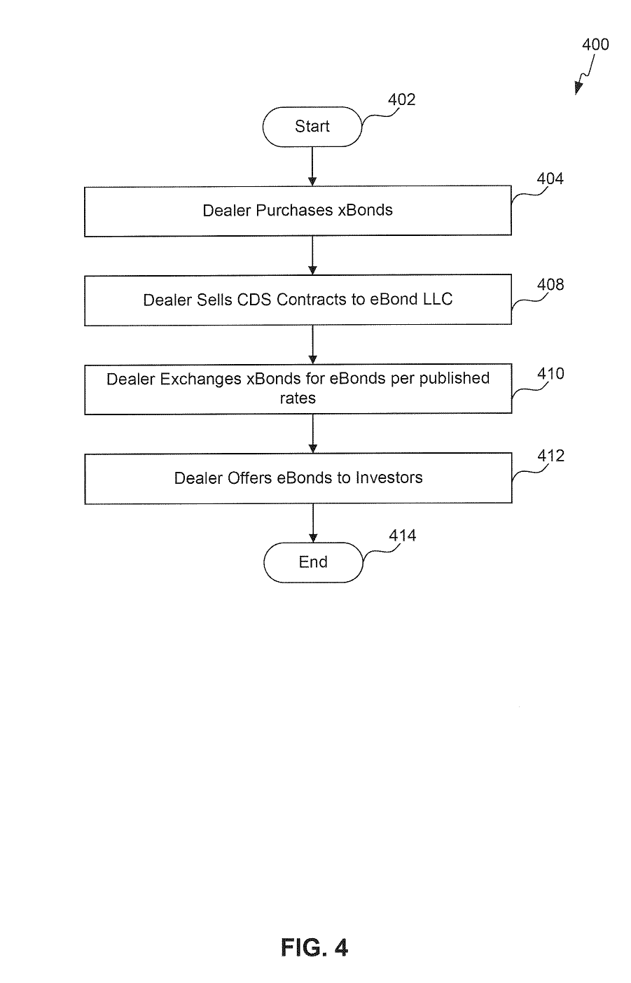

Continuing the previous non-limiting exemplary view of xBond 202 creation, dealer's 104 transactions are now described. FIG. 4 is a flowchart 400 illustrating steps by which a dealer 104 is able to exchange xBonds 202 for eBonds 206, in accordance with an embodiment of the present invention. One skilled in the relevant arts will recognize, as previously noted, that each entity discussed herein may represent a number of different actors, and the exchanges can be performed on a trading platform that permits trading based on the requirements provided by the bond indenture and published exchange requirements.

The method begins at step 402 and proceeds to step 404 where dealer 104 purchases xBonds 202 from bond issuer 102, in accordance with an embodiment of the present invention. As previously noted, and as will be recognized by one skilled in the relevant arts, dealer 104 may, in a non-limiting embodiment, represent one or more dealers 104 perhaps forming a syndicate for the purpose of purchasing issued xBonds 202. However, continued reference to dealer 104 as a single entity is made by way of example, and not limitation.

At this point, dealer 104 is free to offer xBonds 202 to investors 112 as with any other bond issued by bond issuer 102. However, as xBond 202 is not directly backed by a CDS 204 unless first exchanged into an eBond 206, the previous limitations regarding which investors 112 may purchase xBond 202 apply. For example, high grade investors may not have the option of purchasing a poorly rated xBond 202.

Accordingly, dealer 104 may wish to perform the exchange for some or all xBonds 202 into eBonds 206 in order to offer some level of default protection. In order to be able to initiate the exchange for eBonds 206, dealer 104 sells one or more CDS contracts to eBond LLC 109 as specified in the bond indenture at step 408, in accordance with an embodiment of the present invention. eBond LLC 109 uses these CDS contracts 204 as collateral for eCDS contracts which are issued to bond indenture trustee 103 for the benefit of investors in eBonds 206.

The eCDS contracts allow eBond LLC 109 to meet its obligations to the bond indenture trustee 103 under the requirements of the bond indenture, in accordance with an embodiment of the present invention. As will be discussed further below, the eCDS contract provides the security of underlying CDS contracts 204 without the need to pass CDS contracts 204 directly to bond indenture trustee 103. This solution avoids the need for bond indenture trustee 103 to mire itself in the details of fluctuating CDS contract valuations, for example, and provides a single instrument which specifies the precise protection provided by a particular eBond.

In accordance with an embodiment of the present invention, an exemplary CDS contract 204 has zero up-front cost, although one skilled in the relevant arts will understand to apply the following calculations for other up-front costs for other example CDS contracts 204. In a non-limiting example, which will be referred to throughout this disclosure, CDS contract 204 is priced at 100 basis points (i.e., 1% coupon) for a five year period. Over this five year period, the total cost of CDS contract 204 will therefore be 5% of the amount protected by CDS contract 204 in the event of default on secured xBond 202. One skilled in the relevant arts will appreciate that the specifics of a CDS contract 204 may vary, and the aforementioned values are provided as a non-limiting example. By way of example, and not limitation, a CDS contract 204 may have an additional upfront cost.

With an exemplary CDS contract 204 having no upfront cost, dealer 104 may sell

CDS contract 204 to eBond LLC 109 at no upfront cost. eBond LLC 109 then has the responsibility for making the above-referenced coupon payments on the CDS contract, in accordance with an embodiment of the present invention. In exchange, CDS contract 204 secures a principal payout should bond issuer 102 default on repayment of xBond 202.

The bond coupon payments are paid directly to bond indenture trustee 103 by corporate bond issuer 102. Bond indenture trustee 103 distributes these payments directly to bondholders (e.g., investors 112).

With eBond LLC 109 now holding CDS contract 204, dealer 104 exchanges xBonds 202 for eBonds 206 at step 410 per the stipulations of the bond indenture and in accordance with exchange rates published by eBond facilitator 110, in accordance with an embodiment of the present invention. The price of an eBond 206 is reflected by the discounted price of xBond 202 plus the total cost of CDS contract 204. As noted above, for a five year CDS contract 204 with a 1% coupon, the total CDS contract 204 cost is 5% of the notional principal amount. This additional cost is paid by dealer 104 to eBond LLC 109, and is held by eBond LLC 109 to pay for the coupon payments on the CDS contract, in accordance with an embodiment of the present invention. In accordance with a further embodiment of the present invention, the holdings of eBond LLC 109 are placed in an account monitored by bond indenture trustee 103 for compliance with the teams of the bond indenture.

For the purposes of this non-limiting example, the notional principal amount of

CDS contract 204 corresponds to the par value of xBond 202, in accordance with an embodiment of the present invention. In this example, the OID of xBond 202 is equivalent to the total cost of CDS contract 204, or 5%. Therefore, the discounted value of xBond 202 is 95% of par value. Dealer 104 provides the cost of CDS contract 204 and tenders xBonds 202 to eBond LLC 109 in exchange for eBonds 206, in accordance with an embodiment of the present invention.

In order to secure this transaction to bond indenture trustee's 103 satisfaction, eBond LLC 109 provides an eCDS contract to bond indenture trustee 103, in accordance with an embodiment of the present invention. As discussed above, the eCDS contract is backed by the CDS contracts held by eBond LLC 109, and provides a way by which bond indenture trustee 103 can recover losses on behalf of bondholders. The eCDS contract is a bilateral agreement between eBond LLC 109 and bond indenture trustee 103 without involvement of CCP 108, in accordance with an embodiment of the present invention.

The dealer 104 is now able to take eBonds 206 directly to market and sell them to investors 112 at step 412. eBonds 206 from the above non-limiting exemplary transaction are “default-free” bonds termed “e-100” eBonds 206, the “100” meaning they cover 100% of the par value of underlying xBonds 202 in the event of default by bond issuer 102. The term “default-free” in this sense refers to the 100% coverage in the event of default. The aforementioned eCDS contract specifies the level of coverage provided by the particular eBond tranch. For example, the eCDS contract for an “e-100” eBond 206 can specify a default condition for anything less than 100% of payments made, including principal and interest, on the bond. The eCDS contract for an “e-80” eBond 206 can specify a default condition where bond issuer 102 is unable to repay the principal, and provides coverage of 80% of the principal payment. One skilled in the relevant arts will appreciate that other levels of risk and protection can be provided. The method then ends at step 414.

In accordance with a further embodiment of the present invention, the conversion process occurs between tranches of eBonds 206, or back to xBonds 202. For example, a dealer 104 may exchange an “e-80” eBond 206 for an “e-100” eBond 206 by selling the required CDS contract 204 to eBond LLC 109, and making a cash payment to eBond LLC 109 to cover the difference in cost. In an exemplary conversion from an “e-100” eBond 206 to an xBond 202, dealer 104 receives cash based on the stipulated method of the eBond facilitor from eBond LLC 109 and receives the stipulated amount of CDS contracts.

When the requirements for a particular conversion are met (e.g., from xBond 202 to a particular eBond 206 tranch, between eBond 206 tranches, or from an eBond 206 back to an xBond 202), eBond LLC 109 notifies bond indenture trustee 103 of the requested conversion. Bond indenture trustee 103 then performs the actual conversion, effectuating an exchange from a CUSIP number unique to the xBond 202 or particular eBond 206 tranch and another CUSIP number corresponding to the desired bond.

E-100 bonds created in this manner would have excellent creditworthiness, based on the backing provided by CDS contract 204 and secured by the creditworthiness of CCP 108. This allows investors to purchase a standard bond with low or no default risk, thereby increasing the likelihood that bond issuer 102 can find a purchaser for the bonds.

### V. Ebond Intermediation Process

In the above non-limiting exemplary embodiment, the price of xBond 202 was determined based on an assumption of an eBond 206 price at 100% par value and a total CDS cost of 5%. As will be described below, an eBond facilitator 110 may offer a number of different exchanges based on the precise level of default protection investors wish to receive. The various levels of protection are offered as different tranches of an eBond 206, including the above-referenced e-100 default-free bond, and other levels such as, by way of example, and not limitation, e-90 and e-80. In accordance with a further embodiment of the present invention, e-100 bonds are further fully protected for any interest payments.

The discount at which bond issuer 102 must offer original xBond 202 for sale is tied to the price of CDS contracts 204 securing the bond. More precisely, as a bond issuer's 102 credit rating declines, and issued bonds are considered more speculative in nature, the cost of a CDS contract 204 will generally trend upward. As the creditworthiness of a bond issuer 102 increases, CDS contracts 204 backing the bond will generally decrease in cost. The implications of this on the OLD price of xBonds 202 are discussed below.

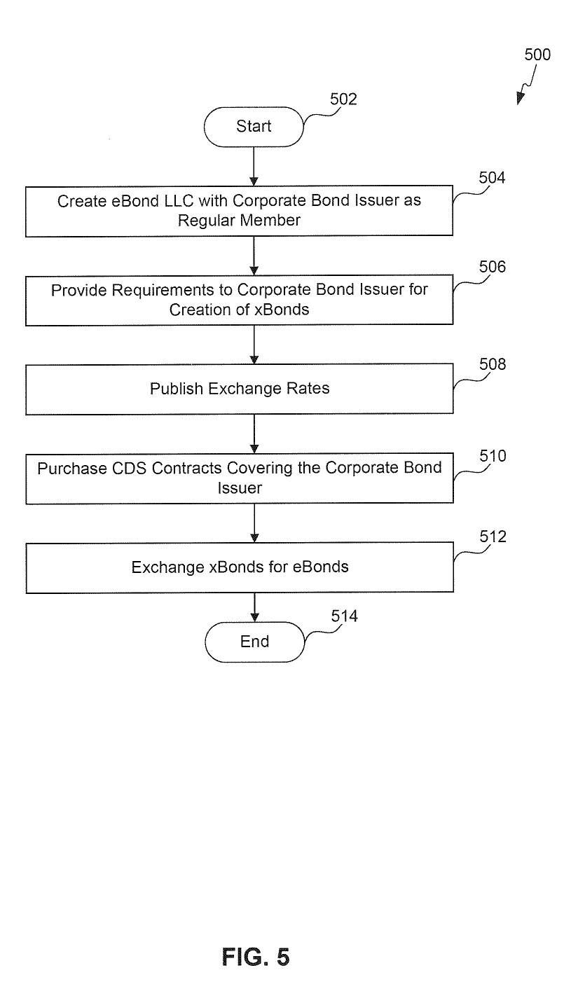

FIG. 5 is a flowchart 500 illustrating steps by which eBond facilitator 110 facilitates the eBond 206 exchange process, in accordance with an embodiment of the present invention. The method begins at step 502 and proceeds to step 504 where an eBond LLC 109 is formed with bond issuer 102 as a regular member, in accordance with a further embodiment of the present invention.

In accordance with an additional embodiment of the present invention, one or more financial advisors, such as eBond facilitator 110, take on the role of managing member(s) of eBond LLC 109, charged with the task of controlling assets (e.g., CDS contracts 204 and cash) in a manner which maintains bankruptcy remote status for the benefit of investors. Bond issuer 102, in its role as a regular member, is required to meet any CDS variation margin calls, if applicable, from CCP 108 and any other payments that are required by the terms of the eBond LLC 109. In particular, bond issuer 102, in its role as regular member of eBond LLC 109, is subject to capital calls at a later date, which allows eBond LLC 109 to always have enough cash on hand to pay accrued interest on the eBond 206. This allows eBond faciliator 110, in its role as managing member of eBond LLC 109, to maintain bankruptcy remoteness.

The method continues at step 506 where requirements are provided as part of the agreement forming eBond LLC 109 regarding applicable parameters for creation of xBonds 202, in accordance with an embodiment of the present invention. As previously discussed, in a non-limiting exemplary embodiment these parameters include a specified date on which any issued xBonds 202 must mature. In a further exemplary embodiment these parameters include a particular CDS contract 204 which is provided by a dealer 104 to eBond LLC 109 as part of the exchange process. These requirements are included in the bond indenture for xBond 202.

At step 508, eBond facilitator 110 publishes exchange rates for eBonds 206, in accordance with an embodiment of the present invention. As previously discussed, this rate will vary with the cost of CDS contracts 204 on the underlying xBond 202, in accordance with a further embodiment of the present invention.

First, eBond facilitator 110 determines the OID price at which xBond 202 should issue, in accordance with an embodiment of the present invention. This is computed by subtracting the costs of a CDS contract 204 on the underlying xBond 202 from the 100% “default-free” protection (i.e., backed by CCP 108) of an e-100 eBond 206. The cost of a CDS contract 204 is determined by adding any upfront costs together with the coupons over the life of CDS contract 204, in accordance with an embodiment of the present invention. The precise amounts of CDS contract 204 costs are determined by calculations which are well-known to those skilled in the relevant arts using industry standard CDS calculations.

As a non-limiting example, assume a bond issuer 102 wishes to issue an xBond that, when exchanged into an e-100 eBond 206, is priced at 100% par value with a yield of 2.75% over five years. In this non-limiting example, a CDS contract 204 for the same five year period can be purchased for 200 basis points with a 1% coupon. The total cost of this exemplary CDS contract 204 is therefore 5% (5 years at 1% coupon) plus the remaining upfront cost associated with the 200 basis point CDS pricing. In this case the upfront cost is calculated to be 4.42%, using industry standard CDS calculations. The total cost of CDS contract 204 over the five year period would therefore be 9.42%.

In accordance with an embodiment of the present invention, bond issuer 102 will need to issue an xBond 202 with a price discounted to 90.58% of par value (100% par value for the e-100 eBond 206 minus the 9.42% total cost of CDS contract 204) and a 4.90% yield. For other tranches of eBonds 206, backing CDS contract 204 covers a reduced liability (e.g., 80% par value for an e-80 eBond 206), in accordance with an embodiment of the present invention. eBonds can be exchanged for eBonds of other tranches, as well as reverted to xBonds, by calculating the delta of the value of CDS contracts 204 of the two instruments and the delta of the prices of the bonds. The total of these cost differences is calculated, and the exchange is made between dealer 104 and eBond issuer 110, with a cash payment made to the appropriate entity based on the differences in value. This exchange rate can also be used to exchange xBonds 202 directly for a particular tranche, such as an e-80 eBond 206.

In accordance with an embodiment of the present invention, eBond facilitator 110 collects fees from bond issuer 102 at the time of issuance for the service of managing the initial eBond 206 offering, such as through the publication of exchange rates determined through the above calculations, and for the ongoing maintenance of the eBond LLC 109 mechanisms. In a non-limiting exemplary embodiment, eBond facilitator 110 adds on a 5 basis point fee at the time of offering. In accordance with a further embodiment of the present invention, eBond facilitator 110 collects an exchange fee from dealer 104 at each exchange. For example, eBond facilitator 110 may assess a fee of $50 for each $1M worth of eBonds exchanged through the aforementioned processes. One skilled in the relevant arts will recognize that other means for monetizing the initial offering and ongoing exchanges may be employed, and the aforementioned means are provided by way of example, and not limitation.

At step 510, eBond LLC 109 purchases the aforementioned CDS contracts 204 from dealer 104, as previously discussed. This allows eBond LLC 109 to provide the required eCDS contract to bond indenture trustee 103, backed by CDS contracts 204, thereby allowing dealer 104 to exchange xBonds 202 into eBonds 206 at step 512 per the terms of the bond indenture. The method ends at step 514.

In accordance with an embodiment of the present invention, eBond facilitator 110 conducts the aforementioned transactions through bond indentured trustee 103, such as the previously mentioned exchange of CUSIP numbers.

### VI. Course of Performance

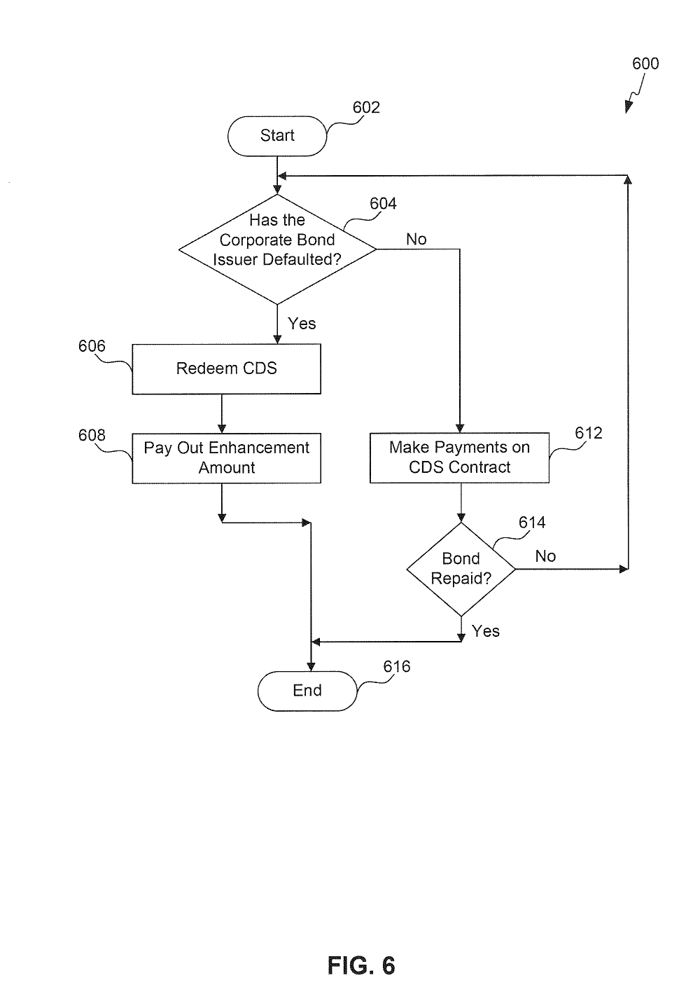

FIG. 6 is a flowchart 600 illustrating a course of performance by eBond LLC 109, in accordance with an embodiment of the present invention. The method begins at step 602 and proceeds to step 604 where a determination is made as to whether bond issuer 102 has defaulted on obligations on the underlying xBond 202. If not, then this means that any coupon payments due are being timely paid by bond issuer 102 to bond indenture trustee 103 for distribution to bondholders. At step 612, eBond LLC 109 uses cash reserves acquired from the initial exchange to make any coupon payments on CDS contract 204.

At step 614, a determination is made as to whether the full amount of xBond 202 has been repaid, and if not, the method begins anew at step 604. If xBond 202 has been repaid, then all party obligations are fulfilled, and the method ends at step 616. In this event, in accordance with an embodiment of the present invention, eBond LLC 109 returns any residual cash to bond issuer 102, per the terms of the eBond LLC membership agreement, such as funds used to protect against a CDS contract 204 call.

If, instead, bond issuer 102 has defaulted on obligations to repay xBond 202, then the eCDS and underlying CDS contracts 204 become redeemable. At step 606, bond indenture trustee 103 notifies investors that all outstanding eBonds are being called for early redemption. The eBonds are then delivered by investors to bond indenture trustee 103, who converts the eBonds back to xBonds and delivers them together with the eCDS contract to eBond LLC 109 for redemption. In turn, the underlying CDS contracts are delivered, together with the xBonds, to the CDS contract issuer (e.g., dealer 104).

The redemption amount of the CDS contracts (e.g., par plus accrued interest in the case of e-100 eBonds, or 80% par in the case of e-80 eBonds) is received by bond indenture trustee 103 for the benefit of, and distribution to, affected bondholders.

One skilled in the relevant arts will recognize that settlements may take place that eliminate the need for one or more of the aforementioned deliveries of bonds and contracts. For example, bond indenture trustee 103 may hold the underlying CDS contracts in trust, and may therefore be able to redeem them directly without first delivering the eCDS contract. Moreover, dealer 104 that acted as principal for the underlying CDS contracts may not want to take delivery of the defaulted xBonds, and instead may simply pay out the CDS contract amount per a settlement agreement. One skilled in the relevant arts will recognize that many different ways of handling the aforementioned exchanges may exist, and are all contemplated within the scope of the present invention.

At step 608, eBond issuer 110 pays out the amount secured by eBond 206 vehicles it has issued, such as 90% par value for an e-90 eBond 206, or 100% par value plus interest for an e-100 eBond 206 (i.e., principal and interest guaranteed bonds), using the funds obtained from redemption of the CDS contract 204 and with cash held by eBond LLC 109. The method then ends at step 616.

### V. Immediate Xbond-to-Ebond Exchange

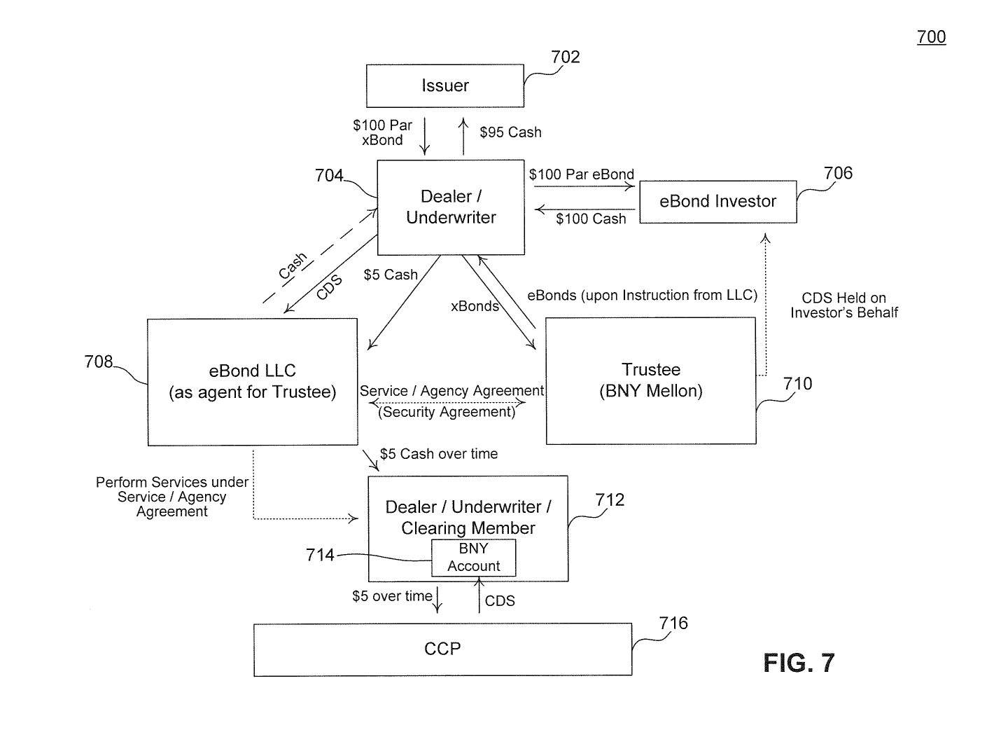

In accordance with an embodiment of the present invention, the purchase of an eBond by an eBond investor is facilitated without the use of an eCDS. FIG. 7 is a diagram 700 illustrating components of a further eBond exchange, in accordance with an embodiment of the present invention.

As before, a corporate bond issuer (or other bond-issuing entity) 702 provides an

OID xBond to a dealer/underwriter 704, in accordance with an embodiment of the present invention. As shown in FIG. 7, in an exemplary non-limiting embodiment, this exchange involves the issuance of a $100 par value xBond for a discounted $95 cash. An eBond investor 706 then pays $100 for a $100 par eBond based on this xBond and backed by a CDS.

An eBond LLC 708 handles the purchasing of a backing CDS and compliance with requirements of CCP 716 and clearing member 712, in accordance with an embodiment of the present invention. As before, for the purposes of the discussion herein, actions taken by, or on behalf of, eBond LLC 708 are generally discussed in the context of an eBond facilitator in its role as managing member. Moreover, although the present description will refer to an LLC corporate structure, one of skill in the relevant arts will recognize that corporate structures other than an LLC may also be created without departing from the spirit and scope of the present invention.

With all of the requirements for the xBond-to-eBond exchange met, trustee 710 performs the exchange with dealer/underwriter 704 upon instruction by eBond LLC 708, in accordance with an embodiment of the present invention. The eBond can then be delivered to eBond investor 706.

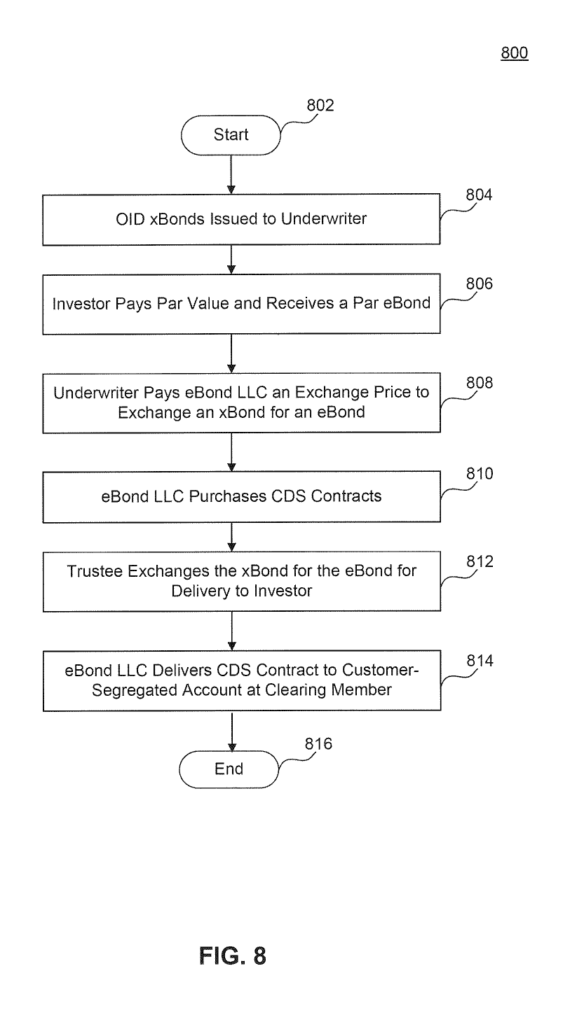

FIG. 8 is a flowchart of a method 800 illustrating steps by which an immediate xBond-to-eBond exchange is effected, in accordance with an embodiment of the present invention. Method 800 is discussed with ongoing reference to diagram 700 of FIG. 7. The method begins at step 802 and proceeds to step 804 where OID xBonds are issued by issuer 702 to a dealer/underwriter 704, in accordance with an embodiment of the present invention. As shown in the non-limiting example of FIG. 7, dealer 704 may pay $95 in exchange for each $100 par xBond from issuer 702. One skilled in the relevant arts will recognize that the discount amount may vary, as previously discussed.

The method then proceeds to step 806, where investor 706 pays the par value for an eBond (e.g., e-100 tranch eBond) in exchange for the eBond, in accordance with an embodiment of the present invention. In the exemplary non-limiting embodiment of FIG. 7, this exchange includes a $100 payment from investor 706 to dealer 704 in exchange for a $100 par eBond. Although both payment and receipt of the eBond can occur simultaneously or nearly-simultaneously from the perspective of eBond investor 706, a number of additional steps take place before the eBond delivered to investor 706 is created, in accordance with an embodiment of the present invention.

At step 808, dealer/underwriter 704 pays eBond LLC 708 an exchange price to effect the exchange of an xBond for an eBond. In the exemplary non-limiting embodiment shown in FIG. 7, this is a $5 payment from dealer 704 to eBond LLC 708. eBond LLC 708 purchases CDS contracts at step 810, which are used to back the eventual eBond, and thereby allow for exchange of the xBond to an eBond, in accordance with an embodiment of the present invention. In accordance with a further embodiment of the present invention, eBond LLC 708 purchases the CDS from dealer 704, but one skilled in the relevant arts will recognize that this purchase may be made from any other CDS dealer.

With the CDS acquired by eBond LLC 708, the requirements for creation of an eBond are met, in accordance with an embodiment of the present invention. eBond LLC 708 instructs trustee 710 to exchange the xBonds for eBonds at step 812, effectuating this exchange with dealer 704. This exchange allows dealer 704 to deliver the eBonds (e.g., $100 par eBonds per the non-limiting example of FIG. 7) to investor 706.

At step 814, in order to secure the CDS with a clearing member, eBond LLC 708 delivers the CDS contracts it holds to trustee 710 or other fiduciary for placement in a customer account, in accordance with an embodiment of the present invention. In accordance with a further embodiment of the present invention, this customer account 714 is associated with investor 706, and is held with a clearing member 712 at a CCP 716. eBond LLC 708 makes the CDS coupon payments to the clearing member 712 or CCP 716 in compliance with a CDS servicing agreement, in accordance with a further embodiment of the present invention. The method then ends at step 816.

In accordance with an embodiment of the present invention, dealer/underwriter 704 and dealer/underwriter/clearing member 712 may be the same or separate entities. Customer account 714 is held, in accordance with a further embodiment of the present invention, by trustee 710 or other fiduciary in its role as trustee, on behalf of investor 706.

In accordance with an embodiment of the present invention, eBond LLC 708 holds enough cash such that, in the event of a default, all CDS coupons can be paid and the last bond interest can be paid. By way of non-limiting example, e-100 tranch eBonds, as previously discussed, are principal and interest guaranteed bonds. Therefore, eBond LLC 708 must be able to pay all CDS coupons in the event of a default in order to recover on the CDS contracts. Typically, if CDS coupons are not paid, the CDS is terminated with no principal paid, although one skilled in the relevant arts will understand that the particulars depends on the precise nature of the CDS contract.

An eBond Reserve Account Formula is used to compute the minimum required cash reserves at any time, in accordance with an embodiment of the present invention.

These minimum cash reserves, in accordance with an embodiment of the present invention, are equal to one CDS coupon plus one-and-a-half bond coupons. As a result, the initial cash held in eBond LLC 708 is equal to the CDS exchange price (upfront CDS costs plus future CDS coupons), but is simultaneously reduced by the upfront CDS cost based on the need for eBond LLC 708 to purchase a CDS contract, leaving the future CDS coupons, in accordance with a further embodiment of the present invention.

Over time, eBond LLC 708 pays out the CDS coupons, as discussed above, which reduces cash reserves, in accordance with an embodiment of the present invention. If cash reserves are reduced below the minimum required, as determined in a non-limiting exemplary embodiment by the eBond Reserve Account Formula, then the managing member of eBond LLC 708 (e.g., eBond facilitator 110 of FIG. 1) initiates a capital call to the regular member of eBond LLC 708 (e.g., issuer 702) for additional cash reserves, in accordance with an embodiment of the present invention. In accordance with an additional embodiment of the present invention, for bankruptcy purposes, issuer 702, as a regular member of eBond LLC 708, has no access to cash reserves except at time of bond retirement.

### VI. Example Computer System Implementation

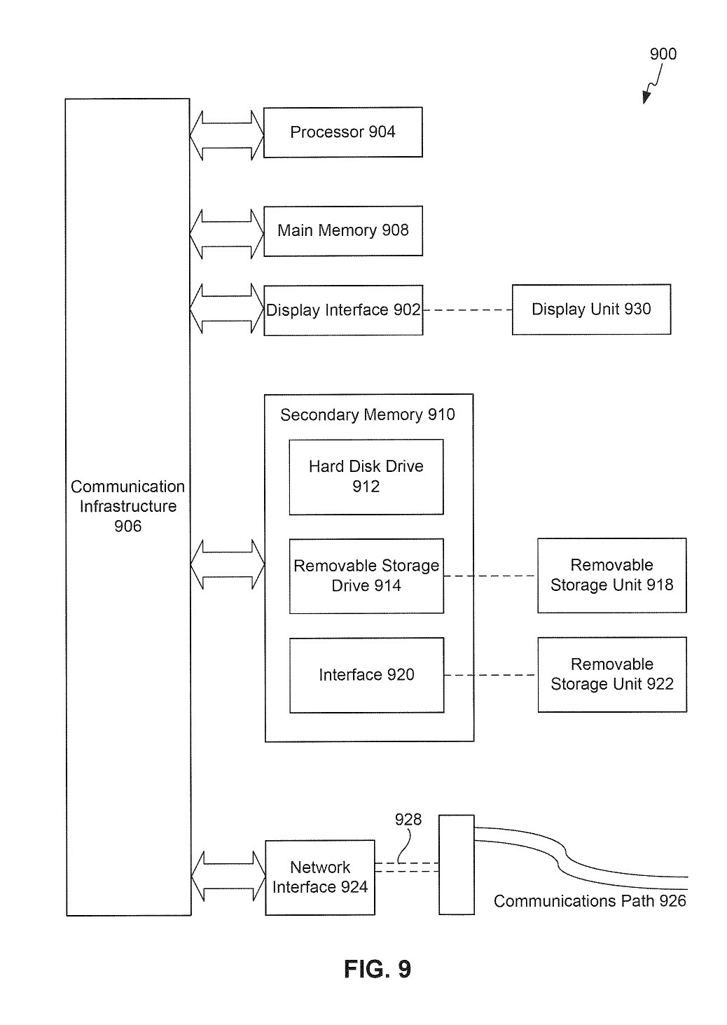

Various aspects of the present invention can be implemented by software, firmware, hardware, or a combination thereof. FIG. 9 illustrates an example computer system 900 in which the present invention, or portions thereof, can be implemented as computer-readable code. For example, the methods illustrated by flowcharts 300 of FIG. 3, 400 of FIG. 4, 500 of FIG. 5, 600 of FIG. 6, and 800 of FIG. 8, can be implemented in system 900. Various embodiments of the invention are described in terms of this example computer system 900. After reading this description, it will become apparent to a person skilled in the relevant art how to implement the invention using other computer systems and/or computer architectures.

Computer system 900 includes one or more processors, such as processor 904. Processor 904 can be a special purpose or a general purpose processor. Processor 904 is connected to a communication infrastructure 906 (for example, a bus or network).

Computer system 900 also includes a main memory 908, preferably random access memory (RAM), and may also include a secondary memory 910. Secondary memory 910 may include, for example, a hard disk drive 912, a removable storage drive 914, and/or a memory stick. Removable storage drive 914 may include a floppy disk drive, a magnetic tape drive, an optical disk drive, a flash memory, or the like. The removable storage drive 914 reads from and/or writes to a removable storage unit 918 in a well known manner. Removable storage unit 918 may include a floppy disk, magnetic tape, optical disk, etc. that is read by and written to by removable storage drive 914. As will be appreciated by persons skilled in the relevant art(s), removable storage unit 918 includes a computer usable storage medium having stored therein computer software and/or data.

In alternative implementations, secondary memory 910 may include other similar means for allowing computer programs or other instructions to be loaded into computer system 900. Such means may include, for example, a removable storage unit 922 and an interface 920. Examples of such means may include a program cartridge and cartridge interface (such as that found in video game devices), a removable memory chip (such as an EPROM, or PROM) and associated socket, and other removable storage units 922 and interfaces 920 that allow software and data to be transferred from the removable storage unit 922 to computer system 900.

Computer system 900 may also include a communications interface 924. Communications interface 924 allows software and data to be transferred between computer system 900 and external devices. Communications interface 924 may include a modem, a network interface (such as an Ethernet card), a communications port, a PCMCIA slot and card, or the like. Software and data transferred via communications interface 924 are in the form of signals that may be electronic, electromagnetic, optical, or other signals capable of being received by communications interface 924. These signals are provided to communications interface 924 via a communications path 926. Communications path 926 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 918, removable storage unit 922, and a hard disk installed in hard disk drive 912. Signals carried over communications path 926 can also embody the logic described herein. Computer program medium and computer usable medium can also refer to memories, such as main memory 908 and secondary memory 910, which can be memory semiconductors (e.g. DRAMs, etc.). These computer program products are means for providing software to computer system 900.

Computer programs (also called computer control logic) are stored in main memory 908 and/or secondary memory 910. Computer programs may also be received via communications interface 924. Such computer programs, when executed, enable computer system 900 to implement the present invention as discussed herein. In particular, the computer programs, when executed, enable processor 904 to implement the processes of the present invention, such as the steps in the methods illustrated by flowcharts 300 of FIG. 3, 400 of FIG. 4, 500 of FIG. 5, 600 of FIG. 6, and 800 of FIG. 8, discussed above. Accordingly, such computer programs represent controllers of the computer system 900. Where the invention is implemented using software, the software may be stored in a computer program product and loaded into computer system 900 using removable storage drive 914, interface 920, hard drive 912 or communications interface 924.

Embodiments of the invention are also directed to computer program products including software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### VI. CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method comprising:
purchasing a credit default swap contract on an exchangeable bond;
instructing a trustee to exchange the exchangeable bond for an enhanced bond for delivery to an investor of the enhanced bond; and
delivering the credit default swap contract to an account held at a clearing member.

2. The method of claim 1, further comprising:
calculating, by one or more computing devices, a price and yield for the enhanced bond;
calculating, by the one or more computing devices, an original issue discount price and yield for the exchangeable bond based on the enhanced bond and a total cost of the credit default swap contract;
calculating, by the one or more computing devices, a rate of exchange based on receipt of the exchangeable bond and the credit default swap contract in exchange for tender of the enhanced bond; and
publishing the rate of exchange.

3. The method of claim 1, further comprising:
making a coupon payment on the credit default swap contract to the clearing member on behalf of the investor.

4. The method of claim 3, further comprising:
calculating minimum cash reserves; and
initiating a capital call on an issuer of the exchangeable bond subject to a determination that cash reserves are below the minimum cash reserves as a result of making the coupon payment.

5. The method of claim 4, wherein calculating the minimum cash reserves comprises calculating the minimum cash reserves based on the coupon payment on the credit default swap contract plus one-and-a-half coupons on the exchangeable bond.

6. The method of claim 1, further comprising:
receiving a payment for effectuating the exchange from the exchangeable bond to the enhanced bond.

7. An article of manufacture including a computer-readable storage medium having stored thereon computer-executable instructions, execution of which, by one or more computing devices, causes the computing devices to perform operations comprising:
purchasing a credit default swap contract on an exchangeable bond;
instructing a trustee to exchange the exchangeable bond for an enhanced bond for delivery to an investor of the enhanced bond; and
delivering the credit default swap contract to an account held at a clearing member.

8. The article of manufacture of claim 7, the operations further comprising:
calculating a price and yield for the enhanced bond;
calculating an original issue discount price and yield for the exchangeable bond based on the enhanced bond and a total cost of the credit default swap contract;
calculating a rate of exchange based on receipt of the exchangeable bond and the credit default swap contract in exchange for tender of the enhanced bond; and
publishing the rate of exchange.

9. The article of manufacture of claim 7, the operations further comprising:
making a coupon payment on the credit default swap contract to the clearing member on behalf of the investor.

10. The article of manufacture of claim 9, the operations further comprising:
calculating minimum cash reserves; and
initiating a capital call on an issuer of the exchangeable bond subject to a determination that cash reserves are below the minimum cash reserves as a result of making the coupon payment.

11. The article of manufacture of claim 9, wherein calculating the minimum cash reserves comprises calculating the minimum cash reserves based on the coupon payment on the credit default swap contract plus one-and-a-half coupons on the exchangeable bond.

12. The article of manufacture of claim 7, the operations further comprising:
receiving a payment for effectuating the exchange from the exchangeable bond to the enhanced bond.

13. A system comprising:
a memory configured to store modules comprising:
a purchasing module configured to purchase a credit default swap contract on an exchangeable bond,
an instructing module configured to instruct a trustee to exchange the exchangeable bond for an enhanced bond for delivery to an investor of the enhanced bond, and
a delivering module configured to deliver the credit default swap contract to an account held at a clearing member; and
one or more processors configured to process the modules.

14. The system of claim 13, further comprising:
a first calculating module configured to calculate a price and yield for the enhanced bond;
a second calculating module configured to calculate an original issue discount price and yield for the exchangeable bond based on the enhanced bond and a total cost of the credit default swap contract;
a third calculating module configured to calculate a rate of exchange based on receipt of the exchangeable bond and the credit default swap contract in exchange for tender of the enhanced bond; and
a publishing module configured to publish the rate of exchange.

15. The system of claim 13, further comprising:
a coupon payment module configured to make a coupon payment on the credit default swap contract to the clearing member on behalf of the investor.

16. The system of claim 15, further comprising:
a fourth calculating module configured to calculate minimum cash reserves; and
a capital call module configured to initiate a capital call on an issuer of the exchangeable bond subject to a determination that cash reserves are below the minimum cash reserves as a result of making the coupon payment.

17. The system of claim 16, wherein the fourth calculating module is further configured to calculate the minimum cash reserves based on the coupon payment on the credit default swap contract plus one-and-a-half coupons on the exchangeable bond.

18. The system of claim 13, further comprising:
a receiving module configured to receive a payment for effectuating the exchange from the exchangeable bond to the enhanced bond.

19. A method comprising:
acquiring an original issue discount exchangeable bond;
receiving payment from an investor for an enhanced bond based on the exchangeable bond;
requesting exchange of the exchangeable bond to the enhanced bond, the enhanced bond backed by a credit default swap contract; and
delivering the enhanced bond to the investor.

20. The method of claim 19, wherein acquiring the exchangeable bond comprises:
acquiring the exchangeable bond from a bond issuer based on a rate of exchange, the rate of exchange having been calculated based on receipt of the exchangeable bond and the credit default swap contract in exchange for tender of the enhanced bond.

21. The method of claim 19, further comprising:
making a payment for effectuating the exchange from the exchangeable bond to the enhanced bond.

22. The method of claim 19, further comprising:
tendering the exchangeable bond to a trustee; and
receiving the enhanced bond from the trustee.

23. An article of manufacture including a computer-readable storage medium having stored thereon computer-executable instructions, execution of which, by one or more computing devices, causes the computing devices to perform operations comprising:
acquiring an original issue discount exchangeable bond;
receiving payment from an investor for an enhanced bond based on the exchangeable bond;
requesting exchange of the exchangeable bond to the enhanced bond, the enhanced bond backed by a credit default swap contract; and
delivering the enhanced bond to the investor.

24. The article of manufacture of claim 23, wherein acquiring the exchangeable bond comprises:
acquiring the exchangeable bond from a bond issuer based on a rate of exchange, the rate of exchange having been calculated based on receipt of the exchangeable bond and the credit default swap contract in exchange for tender of the enhanced bond.

25. The article of manufacture of claim 23, the operations further comprising:
making a payment for effectuating the exchange from the exchangeable bond to the enhanced bond.

26. The article of manufacture of claim 23, the operations further comprising:
tendering the exchangeable bond to a trustee; and
receiving the enhanced bond from the trustee.

27. A system comprising:
a memory configured to store modules comprising:
an acquiring module configured to acquire an original issue discount exchangeable bond,
a receiving module configured to receive payment from an investor for an enhanced bond based on the exchangeable bond,
a requesting module configured to request exchange of the exchangeable bond to the enhanced bond, the enhanced bond backed by a credit default swap contract, and
a delivering module configured to deliver the enhanced bond to the investor; and
one or more processors configured to process the modules.

28. The system of claim 27, wherein the acquiring module is further configured to acquire the exchangeable bond from a bond issuer based on a rate of exchange, the rate of exchange having been calculated based on receipt of the exchangeable bond and the credit default swap contract in exchange for tender of the enhanced bond.

29. The system of claim 27, further comprising:
a payment module configured to make a payment for effectuating the exchange from the exchangeable bond to the enhanced bond.

30. The system of claim 27, further comprising:
a tendering module configured to tender the exchangeable bond to a trustee; and
an enhanced bond receiving module configured to receive the enhanced bond from the trustee.
